(19) United States
(12) Patent Application Publication
(10) Pub. No.: US 2026/0072252 A1
(43) Pub. Date: Mar. 12, 2026

(54) OPTICAL SYSTEM AND IMAGE PICKUP APPARATUS

(71) Applicant: CANON KABUSHIKI KAISHA, Tokyo (JP)

(72) Inventor: Takashi OKADA, Saitama (JP)

(21) Appl. No.: 19/324,217

(22) Filed: Sep. 10, 2025

(30) Foreign Application Priority Data
Sep. 12, 2024 (JP) 2024-158026

(51) Int. Cl. G02B 13/00; G02B 9/60; G02B 9/62

(52) U.S. Cl. CPC G02B 13/0045; G02B 9/60; G02B 9/62

(57) ABSTRACT

Optical systems and image pickup apparatuses are provided herein. One or more optical systems may include a plurality of lenses arranged in order from an object side to an image side. A lens closest to an image plane of the optical system is a negative lens having an inflection point. Predetermined inequalities may be satisfied.

### BACKGROUND

### Field of the Technology

The aspect of the disclosure relates to one or more embodiments of an optical system for imaging.

### Description of the Related Art

For imaging, an optical system that has good optical performance from the center to the periphery of an angle of view, and a reduced size and weight is demanded. U.S. Publication No. 2023/0168470 discloses an optical system that uses a resin-molded aspheric lens.

### SUMMARY

One or more embodiments of an optical system according to one or more aspects of the disclosure may include a plurality of lenses arranged in order from an object side to an image side. A lens closest to an image plane of the optical system is a negative lens having an inflection point. The following inequalities may be satisfied:

$$\begin{matrix}0.5 \leq f / ImgH \leq 0.95 \\ 0. 40 \leq EAR / ImgH / 2 \leq 0.75\end{matrix}$$

where f is a focal length of the optical system, ImgH is an image height, and EAR is an effective diameter of an image-side lens surface of the negative lens. One or more embodiments of an optical system according to another aspect of the disclosure may include five or more lenses. At least two of the five or more lenses may be positive lenses. A lens closest to an image plane of the five or more lenses may be a negative lens having an inflection point where a sign of a curvature of a lens surface of the negative lens changes. One or more image pickup apparatuses may include one or more optical systems in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 illustrates an image pickup apparatus using the optical system according to this embodiment.

### DESCRIPTION OF THE EMBODIMENTS

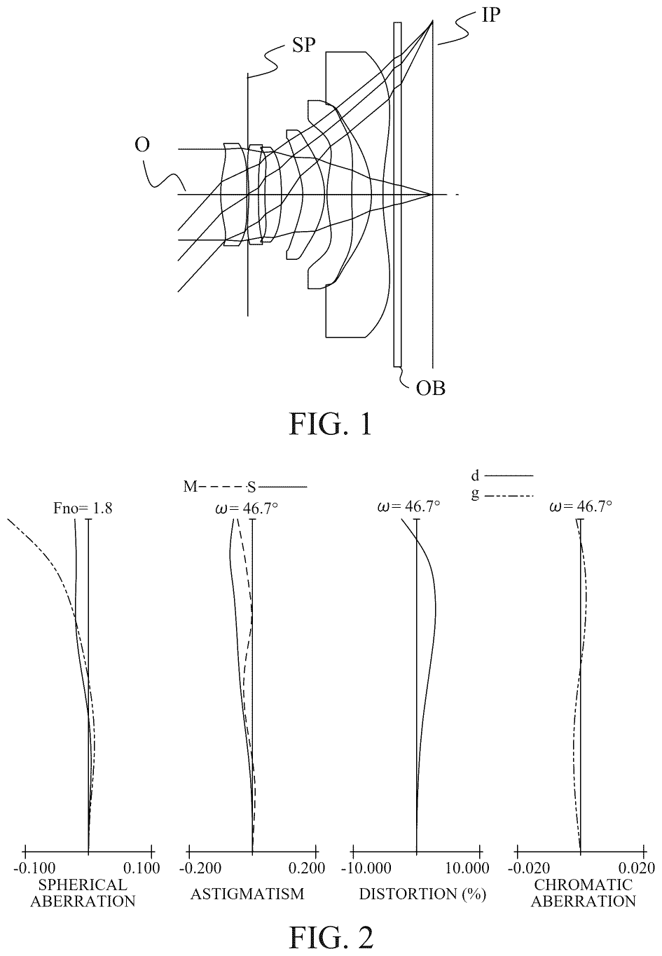

Referring now to the accompanying drawings, a description will be given of embodiments according to the disclosure. Before specific Examples 1 to 4 are described, matters common to each example will be described. FIGS. 1, 3, 5, and 7 illustrate cross sections of the optical systems according to Examples 1, 2, 3, and 4, respectively, in an in-focus state on an object at infinity (referred to as “in an in-focus state at infinity” hereinafter).

The optical system according to each example is used as an imaging optical systems for a variety of image pickup apparatuses, such as video cameras, digital still cameras, smartphone cameras, surveillance cameras, night vision cameras, on-board (in-vehicle) cameras, and film-based cameras. The optical system according to each example may also be used as a projection optical system for an image projection apparatus (projector).

In each figure, a left side is an object side (front side), and a right side is an image side (rear side). O indicates an optical axis of the optical system. The lenses in the optical system will be referred to as an i-th lens (i=1, 2, 3, . . . ) from the object side. SP represents an aperture stop (diaphragm) that determines (limits) a light beam of the maximum aperture, and IP represents an image plane. An imaging surface (light receiving surface) of an image sensor such as a CCD sensor or a CMOS sensor, or a film surface (photosensitive surface) of a silver film is disposed on the image plane IP. An optical block OB that does not have effective refractive power, such as an optical filter (low-pass filter, infrared cut filter, etc.), a face plate, or a sensor protective glass, is provided between a lens closest to the image plane IP and the image plane IP. The optical block OB is not included in the components of the optical system according to each example.

Although not illustrated, the optical system according to each example may include a flare cut diaphragm that cuts out unnecessary light (flare light). The optical system according to each example may perform focusing by moving all or a part of the lenses in the optical system in a direction along the optical axis O (hereinafter referred to as an optical axis direction).

The characteristics of the optical system according to each example will be described below. The optical system according to each example includes a plurality of lenses, and has a negative lens with the strongest refractive power closest to the image plane (referred to as the most image-side negative lens hereinafter). The most image-side negative lens can reduce a distance on the optical axis from the image plane IP to the exit pupil of the optical system (referred to as a pupil distance hereinafter), and as a result, the overall length of the optical system can be reduced. In a case where the pupil distance is reduced, an incident angle of light from the optical system to the image plane (imaging surface) IP increases, the diameter of the most image-side negative lens is reduced, and the size of the optical system can be reduced.

However, The most image-side negative lens causes curvature of field of an off-axis light to be overcorrected due to its divergence action, and generates positive distortion. Thus, an aspheric surface may be disposed to weaken the off-axis negative refractive power. In this case, the image-side lens surface of the most image-side negative lens has an aspheric shape with an inflection point so that the area on the optical axis side is concave toward the image side and the area on the peripheral side is convex toward the image side.

In the aspheric surface, assume that x is a displacement amount from a surface vertex in the optical axis direction, h is a height from the optical axis in a direction orthogonal to the optical axis (radial direction), and x(h) is an aspheric shape. The inflection point is a point where a value of the second derivative obtained by differentiating x(h) twice with respect to h becomes zero, and is also a point (line) where the sign of the second derivative (i.e., curvature) changes before and after that point. More specifically, it means a point where the shape of the lens surface changes from a concave shape to a convex shape, or from a convex shape to a concave shape. Due to the inflection point, the refractive power of the peripheral part can be determined independently of the paraxial refractive power, and it becomes easier to correct the curvature of field. The position of the inflection point can be set at an arbitrary position radially away from the optical axis as long as it is within the effective area (area that contributes to imaging) of the lens surface.

The optical system according to each example may satisfy at least one of the following inequalities:

$$0.5 \leq f / ImgH \leq 0.95 \qquad ( 1 )$$

$$0.4 \leq EAR / ImgH / 2 \leq 0.75 \qquad ( 2 )$$

In inequalities (1) and (2), f is a focal length of the optical system, ImgH is an image height, and EAR is an effective diameter (radius of the effective area) of the image-side lens surface of the most image-side negative lens.

Inequality (1) defines a proper relationship between the focal length of the optical system and the image height. Reducing the overall length of the optical system may reduce the focal length of the optical system and this value is reduced. In a case where f/ImgH becomes higher than the upper limit of inequality (1), the focal length of the optical system becomes too large for the image height, and it becomes difficult to reduce the overall length. In a case where f/ImgH becomes lower than the lower limit of inequality (1), the focal length of the optical system becomes too small for the image height, i.e., the refractive power is too strong, and it becomes difficult to correct curvature of field and distortion.

The lower limit of inequality (1) may be set to 0.60, 0.65, 0.70, or 0.75. The upper limit of inequality (1) may be set to 0.948, 0.945, or 0.942.

Inequality (2) defines a proper relationship between the effective diameter on the image side of the most image-side negative lens and the image height. Reducing the overall length reduces the pupil distance and increases the incident angle of the light beam on the imaging surface, and reduces the effective diameter. In a case where the effective diameter of the most image-side negative lens is reduced, the outer diameter of the negative lens is reduced, and the size of the optical system can be reduced. In a case where EAR/ImgH becomes higher than the upper limit of inequality (2), the effective diameter of the image side of the most image-side negative lens increases, and it becomes difficult to reduce the overall length. In a case where EAR/ImgH becomes lower than the lower limit of inequality (2), the effective diameter on the image side of the most image-side negative lens is reduced, the refractive power of the negative lens increases, and it becomes difficult to correct curvature of field and distortion.

The lower limit of inequality (2) may be set to 0.42, 0.44, 0.46, or 0.48. The upper limit of inequality (2) may be set to 0.748, 0.746, or 0.745.

The optical system according to each example (each numerical example described below) is configured as an optical system having a reduced size and overall length by satisfying inequalities (1) and (2).

The optical system according to each example may have at least one of the following configurations.

The optical system according to each example includes, in order from the object side, a first lens, a second lens, and a third lens. These first to third lenses are responsible for most of the positive refractive power of the optical system, and the lens on the image side of the third lens corrects curvature of field and distortion. At least one of the first, second and third lenses may have positive refractive power, and the combined focal length of these first to third lenses may be close to the focal length of the optical system. Two of the first to third lenses may be positive lenses to distribute the positive refractive power to easily correct spherical aberration and coma. In this way, the first to third lenses share the refractive power, and the lens on the image side of the third lens shares the aberration correction, thereby achieving high optical performance and a reduced overall length (reduced size) of the optical system.

In order to reduce the pupil distance and the overall length, the most image-side negative lens may have strong negative refractive power. In order to correct aberrations while sharing the refractive power on both the object side and image side of this most image-side negative lens, the most image-side negative lens may be a biconcave lens. In a case where an air lens with negative refractive power is disposed adjacent to the most image-side lens on the object side, the curvature of field and distortion can be corrected more effectively. The image-side surface of the air lens, i.e., the object-side lens surface of the most image-side negative lens, may have a shape convex toward the image side.

The most image-side negative lens may be a resin lens. The resin lens can increase the degree of freedom in shape, and satisfactorily correct curvature of field and distortion.

The aperture stop SP may be disposed between any two of the first to third lenses, at a position adjacent to the first lens on the object side, or at a position adjacent to the third lens on the image side. This configuration can increase the height of an off-axis ray in the most image-side negative lens, and improve the correction effect of curvature of field and distortion.

The optical system according to each example may satisfy at least one of the following inequalities (3) to (11):

$$0.7 \leq TTL / ImgH \leq 1.3 \qquad ( 3 )$$

$$0 < skd / ImgH \leq 0.3 \qquad ( 4 )$$

$$0.8 \leq fP / f \leq 1.5 \qquad ( 5 )$$

$$0.6 \leq f 13 / f \leq 1.1 \qquad ( 6 )$$

$$- 1.1 \leq fR / f \leq - 0.5 \qquad ( 7 )$$

$$- 3. \leq R 1 / \vert R 2 \vert \leq - 0.05 \qquad ( 8 )$$

$$0.05 \leq TR / EAR \leq 0.4 \qquad ( 9 )$$

$$- 1.5 \leq sagmax / sagmin < 0 \qquad ( 10 )$$

$$- 0.6 \leq Tk / ImgH \leq - 0.2 \qquad ( 11 )$$

In inequalities (3) to (11), TTL is an on-axis distance (overall length) from a lens surface having refractive power closest to the object in the optical system to the image plane IP, and skd is an air-equivalent value (back focus) of the on-axis distance from a lens surface having refractive power closest to the image plane in the optical system to the image plane. fP is a focal length of the lens having the greatest positive refractive power among the first lens, the second lens, and the third lens, f13 is a combined focal length of the first lens, the second lens, and the third lens, and fR is a focal length of the most image-side negative lens.

The object-side lens surface of the most image-side negative lens may have a concave shape toward the object side, and an air gap (air lens) is formed between the most image-side negative lens and a lens adjacent to it on the object side. In this case, R1 is a radius of curvature of the object-side lens surface of the most image-side negative lens, and R2 is a radius of curvature of the image-side lens surface of the lens adjacent to the most image-side negative lens on the object side. TR is a distance on the optical axis between the object-side lens surface of the most image-side negative lens and the image-side lens surface of the lens adjacent to the most image-side negative lens on the object side (the length on the optical axis of the air lens), and Tk is a pupil distance. sagmax and sagmin are the maximum and minimum sag amounts of the image-side lens surface of the most image-side negative lens, respectively. The sag amount corresponds to x (the displacement amount from the surface vertex in the optical axis direction) in the equation indicating the aspheric shape described later.

Inequality (3) defines a proper relationship between the overall length of the optical system and the image height, and is a condition regarding the size of the optical system. In a case where TTL/ImgH becomes higher than the upper limit of inequality (3), the overall length becomes too large for the image height. In a case where TTL/ImgH becomes lower than the lower limit of inequality (3), the overall length becomes too small for the image height, and it becomes difficult to correct the curvature of field and distortion.

The lower limit of inequality (3) may be set to 0.75, 0.80, 0.85, or 0.90. The upper limit of inequality (3) may be set to 1.28, 1.26, or 1.24.

Inequality (4) defines a proper relationship between back focus and image height. In a case where skd/ImgH becomes higher than the upper limit of (4), the back focus increases, and it becomes difficult to reduce the overall length. In a case where skd/ImgH becomes lower than the lower limit of inequality (4), the back focus is reduced, and it becomes difficult to prevent dust from adhering to the cover glass or filters and appearing in the image.

The lower limit of inequality (4) may be set to 0.10, 0.15, or 0.17. The upper limit of inequality (4) may be set to 0.29 or 0.28.

Inequality (5) defines a proper relationship between the lens with the greatest positive refractive power among the first lens, the second lens, and the third lens, and the focal length of the optical system. In a case where fP/f becomes higher than the upper limit of inequality (5), the focal length of the optical system increases and it becomes difficult to reduce the distance to the image plane IP and finally the overall length. In a case where fP/f becomes lower than the lower limit of inequality (5), the refractive power of the lens with the greatest positive refractive power increases and it becomes difficult to correct spherical aberration and coma.

The lower limit of inequality (5) may be set to 0.85, 0.90, 0.95, or 1.00. The upper limit of inequality (5) may be set to 1.40, 1.35, or 1.3.

Inequality (6) defines a proper relationship between the combined focal length of the first lens, the second lens, and the third lens, and the focal length of the optical system. In a case where f13/f becomes higher than the upper limit of inequality (6), the focal length of the optical system increases and it becomes difficult to reduce the distance to the image plane IP and finally the overall length. In a case where f13/f becomes lower than the lower limit of inequality (6), even if the refractive power is distributed by the first lens, the second lens, and the third lens, the spherical aberration and coma generated by these lenses cannot be satisfactorily suppressed.

The lower limit of inequality (6) may be set to 0.70, 0.75, or 0.80. The upper limit of inequality (6) may be set to 1.05, 1.04, or 1.03.

Inequality (7) defines a proper relationship between the focal length of the image-most negative lens and the focal length of the optical system. In a case where fR/f becomes higher than the upper limit of inequality (7), the pupil distance cannot be reduced and the overall length increases. In a case where fR/f becomes lower than the lower limit of inequality (7), the refractive power of the image-most negative lens increases and it becomes difficult to correct curvature of field and distortion even if an aspheric surface is used.

The lower limit of inequality (7) may be set to −1.00, −0.95, or −0.90. The upper limit of inequality (7) may be set to −0.60, −0.65, or −0.70.

Inequality (8) defines a proper shape of the air lens formed on the object side of the most image-side negative lens. In a case where R1/|R2| becomes higher than the upper limit of inequality (8), the curvature of the image-side surface of the air lens increases and it becomes difficult to correct the curvature of field and distortion. In a case where R1/|R2| becomes lower than the lower limit of inequality (8), the curvature of the image-side surface of the air lens becomes too gentle, the negative refractive power of the air lens decreases, and it becomes difficult to reduce the pupil distance and finally the overall length.

The lower limit of inequality (8) may be set to −2.5, −2.0, −1.8, or −1.7. The upper limit of inequality (8) may be set to −0.1, −0.2, or −0.25.

Inequality (9) defines a proper relationship between the length of the air lens formed on the object side of the most image-side negative lens and the effective diameter of the lens surface on the image side of the most image-side negative lens. In a case where TR/EAR becomes higher than the upper limit of inequality (9), the length of the air lens increases and it becomes difficult to reduce the overall length. In a case where TR/EAR becomes lower than the lower limit of inequality (9), the length of the air lens is reduced, the negative refractive power of the air lens decreases, and it becomes difficult to reduce the pupil distance and finally the overall length.

The lower limit of inequality (9) may be set to 0.06 or 0.07. The upper limit of inequality (9) may be set to 0.35, 0.30, or 0.28.

Inequality (10) defines a proper shape of the image-side lens surface of the most image-side negative lens, i.e., the sag amount. In a case where sagmax/sagmin becomes higher than the upper limit of inequality (10), the refractive power of the image-most negative lens is reduced or the curvature of the object-side lens surface of the image-most negative lens increases, and it becomes difficult to reduce the overall length and correct aberrations at the same time. In a case where sagmax/sagmin becomes lower than the lower limit of inequality (10), the undulation of the image-side lens surface of the image-most negative lens increases, and it becomes difficult to mold the image-most negative lens.

The lower limit of inequality (10) may be set to −1.4, −1.3, or −1.25.

Inequality (11) defines a proper relationship between the pupil distance and image height of the optical system. In a case where Tk/ImgH becomes higher than the upper limit of inequality (11), the pupil distance is reduced, and it becomes difficult to correct curvature of field and distortion with the image-most negative lens. In a case where Tk/ImgH becomes lower than the lower limit of inequality (11), the pupil distance increases, and it becomes difficult to reduce the overall length.

The lower limit of inequality (11) may be set to −0.57, −0.55, or −0.53. The upper limit of inequality (11) may be set to −0.30, −0.32, or −0.34.

Examples 1 to 4 will be described in detail below. After Example 4, numerical examples 1 to 4 corresponding to Examples 1 to 4, respectively, will be illustrated.

### Example 1

An optical system according to Example 1 (numerical example 1) illustrated in FIG. 1 has a focal length of 3.322 mm, an F-number of 1.798, and a half angle of view of 46.736°. The optical system according to this example includes six lenses with positive, negative, positive, positive, positive, and negative refractive powers arranged in this order from the object side to the image side. All six lenses are aspherical lenses with both sides formed as aspherical. The aperture stop SP is disposed between the first lens and the second lens.

FIG. 2 illustrates longitudinal aberration (spherical aberration, astigmatism, distortion, and chromatic aberration) of the optical system according to numerical example 1. In the spherical aberration diagram, Fno represents an F-number. A solid line indicates a spherical aberration amount for the d-line (with a wavelength of 587.6 nm), and an alternate long and two short dashes line indicates a spherical aberration amount for the g-line (with a wavelength of 435.8 nm). In the astigmatism diagram, a solid line S indicates an astigmatism amount on a sagittal image plane, and a broken line M indicates an astigmatism amount on a meridional image plane. The distortion diagram indicates a distortion amount for the d-line. The chromatic aberration diagram indicates a lateral chromatic aberration amount for the g-line. ω is a half angle of view (°). The above description of the aberration diagrams is similarly applicable to other numerical examples described later.

### Example 2

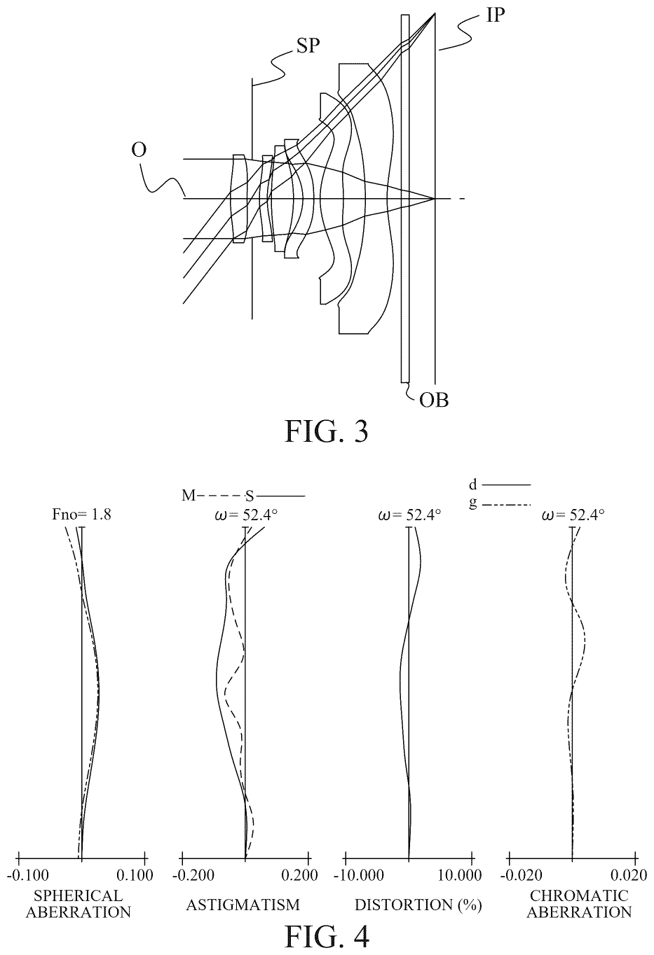

An optical system according to Example 2 (numerical example 2) illustrated in FIG. 3 has a focal length of 2.718 mm, an F-number of 1.798, and a half angle of view of 52.401°. The optical system according to this example includes six lenses with positive, negative, positive, negative, positive, and negative refractive powers arranged in this order from the object side to the image side. All of the six lenses are aspherical lenses with both sides formed as aspherical. The aperture stop SP is disposed between the first lens and the second lens.

FIG. 4 illustrates the longitudinal aberration of the optical system according to numerical example 2.

### Example 3

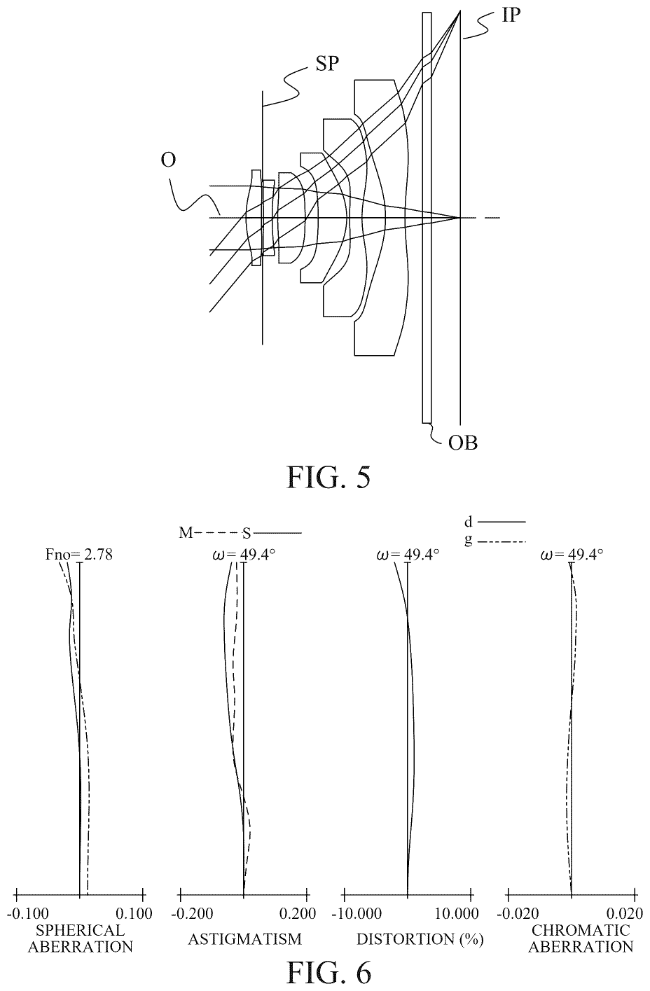

An optical system according to Example 3 (numerical example 3) illustrated in FIG. 5 has a focal length of 3.025 mm, an F-number of 2.785, and a half angle of view of 49.404°. The optical system according to this example includes six lenses with positive, negative, positive, positive, negative, and negative refractive powers arranged in this order from the object side to the image side. All of the six lenses are aspherical lenses with both sides formed as aspherical. The aperture stop SP is disposed between the first lens and the second lens.

FIG. 6 illustrates the longitudinal aberration of the optical system according to numerical example 3.

### Example 4

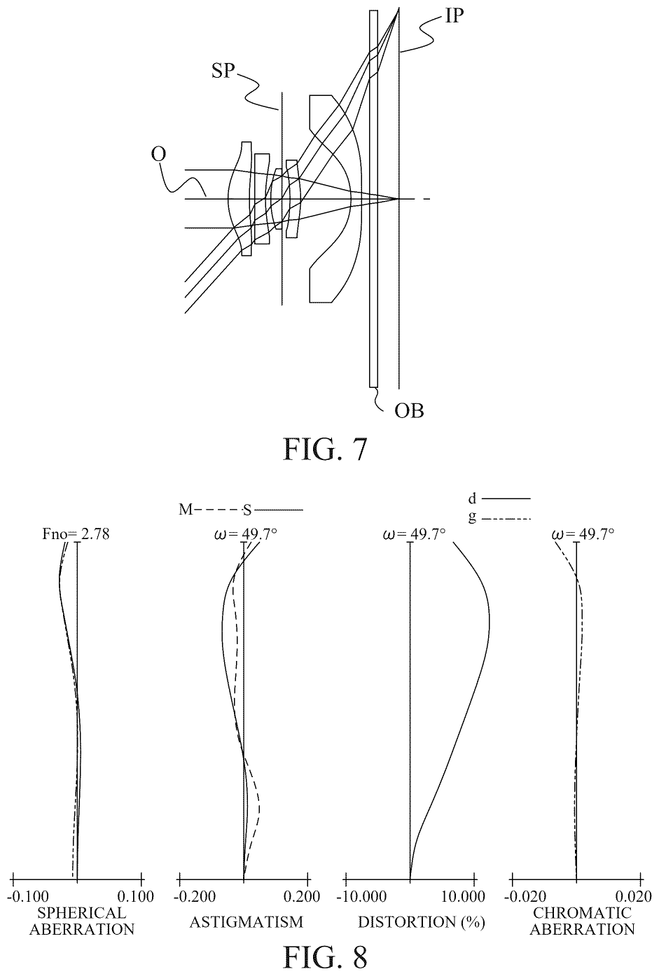

An optical system according to Example 4 (numerical example 4) illustrated in FIG. 7 has a focal length of 2.997 mm, an F-number of 2.782, and a half angle of view of 49.671°. The optical system according to this example includes five lenses with positive, negative, positive, positive, negative, and negative refractive powers arranged in this order from the object side to the image side. All of the five lenses are aspherical lenses with both sides formed as aspherical. The aperture stop SP is disposed between the third lens and the fourth lens. Due to the aperture stop SP disposed in the middle of the optical system, the first lens can share in the correction of curvature of field and distortion.

FIG. 8 illustrates the longitudinal aberration of the optical system according to numerical example 4.

Numerical examples 1 to 4 will be illustrated below. A surface number i in each numerical example represents the order of the optical surfaces counted from the object side, r represents a paraxial radius of curvature (mm) of the i-th surface, which is the i-th optical surface, and d represents a lens thickness or air gap (mm) on the optical axis between i-th and (i+1)-th surfaces. nd represents a refractive index for the d-line of an optical material between i-th and (i+1)-th surfaces, and vd is an Abbe number based on the d-line of an optical material between i-th and (i+1)-th surfaces. The Abbe number vd based on the d-line is expressed as:

$$v d = ( Nd - 1 ) / ( NF - NC )$$

where Nd, NF, and NC are refractive indices for the d-line (587.6 nm), F-line (486.1 nm), and C-line (656.3 nm) in the Fraunhofer lines.

As discussed above, the effective diameter is a diameter (mm) of the effective area of the i-th lens surface through which light rays that contribute to imaging pass.

skd represents back focus (mm). The back focus is an air-equivalent length representing a distance on the optical axis from a lens surface closest to the image plane (final surface) in the optical system to the paraxial image plane. An overall lens length is a distance on the optical axis from a lens surface closest to an object (front surface) of the optical system to a final surface plus the back focus.

An asterisk “*” next to a surface number means that the surface has an aspheric shape. The aspheric shape is expressed by the following equation:

$$x = ( {h}^{2} / R ) / [ 1 + {\{ 1 - ( 1 + K ) {( h / R )}^{2} \}}^{1 / 2} ] + A 4 \cdot {h}^{4} + A 6 \cdot {h}^{6} + A 8 \cdot {h}^{8} + A 10 \cdot {h}^{10} + A 12 \cdot {h}^{12}$$

where x is a displacement amount from a surface vertex in the optical axis direction, h is a height from the optical axis in a direction orthogonal to the optical axis, a light traveling direction is positive, R is a paraxial radius of curvature, K is a conic constant, and A4, A6, A8, A10, and A12 are aspheric coefficients.

“e+M” in the conic constant and aspheric coefficients means×10^{±M}. Table 1 summarizes values relating to inequalities (1) to (11) in numerical examples 1 to 4. Each numerical example satisfies all of inequalities (1) to (11).

### Numerical Example 1

UNIT: mm
SURFACE DATA

| | | | | | Effective |
|---|---|---|---|---|---|
| Surface No. | r | d | nd | νd | Diameter |
| 1* | 2.1540 | 0.537 | 1.53500 | 55.73 | 1.85 |
| 2* | 52.0828 | 0.019 | | | 1.89 |
| 3 (SP) | ∞ | 0.019 | | | 1.84 |
| 4* | −4.5286 | 0.200 | 1.68040 | 18.10 | 1.84 |
| 5* | −3541.7250 | 0.130 | | | 1.74 |
| 6* | 4.9065 | 0.342 | 1.53500 | 55.73 | 1.72 |
| 7* | −3.5224 | 0.434 | | | 1.75 |
| 8* | −1.1938 | 0.446 | 1.53500 | 55.73 | 2.19 |
| 9* | −1.3349 | 0.050 | | | 2.50 |
| 10* | 1.9889 | 0.507 | 1.53500 | 55.73 | 2.81 |
| 11* | 7.1738 | 0.403 | | | 3.48 |
| 12* | −1.8433 | 0.237 | 1.53500 | 55.73 | 3.50 |
| 13* | 4.6774 | 0.224 | | | 5.25 |
| 14 | ∞ | 0.150 | 1.56300 | 51.30 | 6.20 |
| 15 | ∞ | 0.647 | | | 6.20 |
| Image Plane | ∞ | | | | |

ASPHERIC DATA

1st Surface
K = 0.00000e+00 A 4 = −8.14108e−02 A 6 = −2.58854e−02 A 8 = −1.29269e−01
A10 = 6.16829e−02
2nd Surface
K = 0.00000e+00 A 4 = −1.53706e−01
4th Surface
K = 0.00000e+00 A 4 = 1.30697e−01
5th Surface
K = 0.00000e+00 A 4 = 1.65609e−01 A 6 = −7.88063e−02
6th Surface
K = 0.00000e+00 A 4 = −5.72367e−02 A 6 = −1.12574e−01 A 8 = −8.06172e−02
7th Surface
K = 0.00000e+00 A 4 = 8.44583e−03 A 6 = −4.89279e−02 A 8 = −1.40782e−01
A10 = 6.24752e−02
8th Surface
K = 0.00000e+00 A 4 = 4.47776e−01 A 6 = −3.60718e−01 A 8 = 2.29893e−01
A10 = −2.68004e−02
9th Surface
K = 0.00000e+00 A 4 = 1.48357e−01 A 6 = −7.27908e−02 A 8 = 2.54562e−02
A10 = 1.53782e−02
10th Surface
K = 0.00000e+00 A 4 = −2.18130e−01 A 6 = 6.23217e−02 A 8 = −6.71843e−02
A10 = 1.38505e−02 A12 = 2.06156e−03
11th Surface
K = 0.00000e+00 A 4 = −9.22420e−02 A 6 = 3.13727e−02 A 8 = −4.12448e−02
A10 = 2.05818e−02 A12 = −3.04928e−03
12th Surface
K = 0.00000e+00 A 4 = 3.90588e−02 A 6 = −1.61074e−02 A 8 = 7.22856e−03
13th Surface
K = 0.00000e+00 A 4 = −2.57105e−02 A 6 = 1.63764e−03 A 8 = −1.04485e−04

VARIOUS DATA

| | |
|---|---|
| Focal Length | 3.322 |
| Fno | 1.798 |
| Half Angle of View (°) | 46.736 |
| Image Height | 3.530 |
| Overall Lens Length | 4.345 |
| skd (inair) | 0.967 |
| Entrance Pupil Position | 0.406 |
| Exit Pupil Position | −1.786 |
| Front Principal-Point Position | −0.807 |
| Rear Principal-Point Position | −2.675 |

SINGLE LENS DATA

| Lens | Starting Surface | Focal Length |
|---|---|---|
| 1 | 1 | 4.184 |
| 2 | 4 | −6.664 |
| 3 | 6 | 3.888 |
| 4 | 8 | 207.272 |
| 5 | 10 | 4.974 |
| 6 | 12 | −2.441 |

### Numerical Example 2

UNIT: mm
SURFACE DATA

| | | | | | Effective |
|---|---|---|---|---|---|
| Surface No. | r | d | nd | νd | Diameter |
| 1* | 2.7815 | 0.321 | 1.53500 | 55.73 | 1.52 |
| 2* | 10.7662 | 0.095 | | | 1.52 |
| 3 (SP) | ∞ | 0.141 | | | 1.48 |
| 4* | 1.8256 | 0.150 | 1.67070 | 19.30 | 1.42 |
| 5* | 1.6388 | 0.080 | | | 1.49 |
| 6* | 5.3353 | 0.422 | 1.53500 | 55.73 | 1.61 |
| 7* | −2.4970 | 0.180 | | | 1.83 |
| 8* | −1.0432 | 0.209 | 1.67070 | 19.30 | 1.82 |
| 9* | −3.3981 | 0.121 | | | 2.05 |
| 10* | 1.5395 | 0.448 | 1.61550 | 25.80 | 2.92 |
| 11* | −2.3821 | 0.421 | | | 3.65 |
| 12* | −3.8540 | 0.416 | 1.67070 | 19.30 | 3.76 |
| 13* | 2.6357 | 0.271 | | | 4.88 |
| 14 | ∞ | 0.150 | 1.56300 | 51.30 | 6.20 |
| 15 | ∞ | 0.500 | | | 6.20 |
| Image Plane | ∞ | | | | |

ASPHERIC DATA

1st Surface
K = 0.00000e+00 A 4 = −1.10520e−01 A 6 = −1.54797e−02 A 8 = −9.67059e−02
A10 = 3.11710e−02
2nd Surface
K = 0.00000e+00 A 4 = −1.96247e−01
4th Surface
K = 0.00000e+00 A 4 = −3.53892e−01 A 6 = 6.75138e−02
5th Surface
K = 0.00000e+00 A 4 = −2.92276e−01 A 6 = 3.39016e−02
6th Surface
K = 0.00000e+00 A 4 = 6.88524e−03 A 6 = −1.33536e−02 A 8 = −1.36976e−02
7th Surface
K = 0.00000e+00 A 4 = −1.67506e−03 A 6 = −1.37711e−02 A 8 = 5.94318e−02
8th Surface
K = 0.00000e+00 A 4 = −6.44818e−02 A 6 = 5.55446e−01 A 8 = −4.89780e−01
A10 = 3.95026e−01
9th Surface
K = 0.00000e+00 A 4 = −6.55469e−01 A 6 = 8.53273e−01 A 8 = −5.99959e−01
A10 = 2.35025e−01
10th Surface
K = 0.00000e+00 A 4 = −1.53816e−01 A 6 = 1.75684e−01 A 8 = −2.08703e−01
A10 = 7.89850e−02 A12 = −1.25776e−02
11th Surface
K = 0.00000e+00 A 4 = 7.29221e−01 A 6 = −6.04810e−01 A 8 = 2.35636e−01
A10 = −4.53760e−02 A12 = 3.40406e−03
12th Surface
K = 0.00000e+00 A 4 = 1.58466e−01 A 6 = −2.14184e−01 A 8 = 1.22155e−01
A10 = −3.08379e−02 A12 = 2.81198e−03
13th Surface
K = 0.00000e+00 A 4 = −1.06563e−01 A 6 = 1.92478e−02 A 8 = −1.74094e−03

VARIOUS DATA

| | |
|---|---|
| Focal Length | 2.718 |
| Fno | 1.798 |
| Half Angle of View (°) | 52.401 |
| Image Height | 3.530 |
| Overall Lens Length | 3.925 |
| skd (inair) | 0.867 |
| Entrance Pupil Position | 0.322 |
| Exit Pupil Position | −1.848 |
| Front Principal-Point Position | −0.107 |
| Rear Principal-Point Position | −2.218 |

SINGLE LENS DATA

| Lens | Starting Surface | Focal Length |
|---|---|---|
| 1 | 1 | 6.913 |
| 2 | 4 | −35.244 |
| 3 | 6 | 3.240 |
| 4 | 8 | −2.327 |
| 5 | 10 | 1.588 |
| 6 | 12 | −2.275 |

### Numerical Example 3

UNIT: mm
SURFACE DATA

| | | | | | Effective |
|---|---|---|---|---|---|
| Surface No. | r | d | nd | νd | Diameter |
| 1* | 1.5570 | 0.264 | 1.53500 | 55.73 | 1.48 |
| 2* | 6.8551 | 0.019 | | | 1.30 |
| 3 (SP) | ∞ | 0.019 | | | 1.22 |
| 4* | −7.9597 | 0.150 | 1.68040 | 18.10 | 1.17 |
| 5* | 6.6916 | 0.094 | | | 1.02 |
| 6* | 3.7356 | 0.471 | 1.53500 | 55.73 | 1.01 |
| 7* | −4.7547 | 0.224 | | | 1.40 |
| 8* | −4.4005 | 0.489 | 1.53500 | 55.73 | 1.60 |
| 9* | −1.1384 | 0.050 | | | 2.01 |
| 10* | 3.5594 | 0.213 | 1.53500 | 55.73 | 2.12 |
| 11* | 1.7930 | 0.403 | | | 3.06 |
| 12* | −1.8293 | 0.333 | 1.53500 | 55.73 | 3.21 |
| 13* | 3.9086 | 0.303 | | | 4.27 |
| 14 | ∞ | 0.150 | 1.56300 | 51.30 | 6.20 |
| 15 | ∞ | 0.500 | | | 6.20 |
| Image Plane | ∞ | | | | |

ASPHERIC DATA

1st Surface
K = 0.00000e+00 A 4 = −1.34200e−01 A 6 = −1.88171e−01 A 8 = −3.36325e−01
A10 = 3.82815e−01
2nd Surface
K = 0.00000e+00 A 4 = −1.99344e−01
4th Surface
K = 0.00000e+00 A 4 = 1.40615e−01
5th Surface
K = 0.00000e+00 A 4 = 1.57500e−01 A 6 = −1.43797e−01
6th Surface
K = 0.00000e+00 A 4 = −1.93695e−01 A 6 = 6.99704e−02 A 8 = −8.17960e−01
7th Surface
K = 0.00000e+00 A 4 = −2.00303e−01 A 6 = −3.01398e−01 A 8 = −5.83509e−02
A10 = −5.69628e−01
8th Surface
K = 0.00000e+00 A 4 = 9.61061e−03 A 6 = −3.30501e−01 A 8 = 2.49984e−01
A10 = −5.61774e−01
9th Surface
K = 0.00000e+00 A 4 = 1.25070e−01 A 6 = 1.50515e−01 A 8 = −1.83233e−01
A10 = 1.40005e−01
10th Surface
K = 0.00000e+00 A 4 = −4.82125e−01 A 6 = 2.43761e−01 A 8 = −4.34741e−01
A10 = 2.90344e−01 A12 = −3.66902e−02
11th Surface
K = 0.00000e+00 A 4 = −3.08245e−01 A 6 = 9.27313e−02 A 8 = −1.59675e−02
A10 = 5.00974e−03 A12 = −1.71245e−03
12th Surface
K = 0.00000e+00 A 4 = 8.44218e−02
13th Surface
K = 0.00000e+00 A 4 = −1.00078e−01 A 6 = 2.99480e−02 A 8 = −4.98787e−03
A10 = 3.26481e−04

VARIOUS DATA

| | |
|---|---|
| Focal Length | 3.025 |
| Fno | 2.785 |
| Half Angle of View (°) | 49.404 |
| Image Height | 3.530 |
| Overall Lens Length | 3.682 |
| skd (inair) | 0.899 |
| Entrance Pupil Position | 0.204 |
| Exit Pupil Position | −1.627 |
| Front Principal-Point Position | −1.073 |
| Rear Principal-Point Position | −2.525 |

SINGLE LENS DATA

| Lens | Starting Surface | Focal Length |
|---|---|---|
| 1 | 1 | 3.701 |
| 2 | 4 | −5.321 |
| 3 | 6 | 3.987 |
| 4 | 8 | 2.728 |
| 5 | 10 | −7.050 |
| 6 | 12 | −2.283 |

### Numerical Example 4

UNIT: mm
SURFACE DATA

| | | | | | Effective |
|---|---|---|---|---|---|
| Surface No. | r | d | nd | νd | Diameter |
| 1* | 1.2026 | 0.400 | 1.53500 | 55.73 | 1.92 |
| 2* | 3.7886 | 0.100 | | | 1.69 |
| 3* | 26.4153 | 0.200 | 1.68040 | 18.10 | 1.52 |
| 4* | 2.6002 | 0.100 | | | 1.24 |
| 5* | 1.8750 | 0.209 | 1.53500 | 55.73 | 1.02 |
| 6* | −16.9570 | 0.000 | | | 0.85 |
| 7 (SP) | ∞ | 0.150 | | | 0.85 |
| 8* | −2.7130 | 0.200 | 1.68040 | 18.10 | 1.07 |
| 9* | −2.0055 | 0.941 | | | 1.31 |
| 10* | −1.4169 | 0.200 | 1.53500 | 55.73 | 2.36 |
| 11* | 48.8756 | 0.150 | | | 3.50 |
| 12 | ∞ | 0.150 | 1.56300 | 51.30 | 6.20 |
| 13 | ∞ | 0.400 | | | 6.20 |
| Image Plane | ∞ | | | | |

ASPHERIC DATA

1st Surface
K = 0.00000e+00 A 4 = −9.46581e−02 A 6 = −7.29938e−03 A 8 = −3.68665e−01
A10 = 1.91235e−01
2nd Surface
K = 0.00000e+00 A 4 = −1.09360e−01
3rd Surface
K = 0.00000e+00 A 4 = −2.80556e−02
4th Surface
K = 0.00000e+00 A 4 = −2.71697e−02 A 6 = −1.56441e−01 A 8 = −6.41411e−01
A10 = 1.52047e+00
5th Surface
K = 0.00000e+00 A 4 = 1.52000e−01
6th Surface
K = 0.00000e+00 A 4 = 1.70206e−01 A 6 = 7.44171e−02 A 8 = −4.32500e−01
A10 = −3.29782e+00
8th Surface
K = 0.00000e+00 A 4 = 1.19178e−01 A 6 = 3.16565e−01 A 8 = −5.79887e−01
A10 = −8.64080e+00 A12 = 1.08679e+01
9th Surface
K = 0.00000e+00 A 4 = 2.62555e−01 A 6 = −3.68056e−01 A 8 = 3.56426e+00
A10 = −1.11272e+01 A12 = 1.05768e+01
10th Surface
K = 0.00000e+00 A 4 = −2.62822e−01 A 6 = 1.72009e−01
11th Surface
K = 0.00000e+00 A 4 = −1.38702e−01 A 6 = 7.03018e−02 A 8 = −1.95097e−02
A10 = 2.01158e−03

VARIOUS DATA

| | |
|---|---|
| Focal Length | 2.997 |
| Fno | 2.782 |
| Half Angle of View (°) | 49.671 |
| Image Height | 3.530 |
| Overall Lens Length | 3.200 |
| skd (inair) | 0.646 |
| Entrance Pupil Position | 0.981 |
| Exit Pupil Position | −1.206 |
| Front Principal-Point Position | −1.612 |
| Rear Principal-Point Position | −2.596 |

SINGLE LENS DATA

| Lens | Starting Surface | Focal Length |
|---|---|---|
| 1 | 1 | 3.125 |
| 2 | 3 | −4.253 |
| 3 | 5 | 3.168 |
| 4 | 8 | 10.142 |
| 5 | 10 | −2.570 |

TABLE 1

Numerical Example

| | 1 | 2 | 3 | 4 |
|---|---|---|---|---|
| (1) f/ImgH | 0.941 | 0.770 | 0.857 | 0.849 |
| (2)EAR/ImgH/2 | 0.744 | 0.691 | 0.605 | 0.496 |
| (3)TTL/ImgH | 1.231 | 1.112 | 1.043 | 0.907 |
| (4)skd/ImgH | 0.274 | 0.246 | 0.255 | 0.183 |
| (5)fP/f | 1.170 | 1.192 | 1.223 | 1.043 |
| (6)fP13/f | 0.924 | 0.954 | 1.029 | 0.875 |
| (7)fR/f | −0.735 | −0.837 | −0.755 | −0.858 |
| (8)R1/\|R2\| | −0.257 | −1.618 | −1.020 | −0.707 |
| (9)TR/EAR | 0.077 | 0.086 | 0.094 | 0.269 |
| (10)sagmax/sagmin | −1.2010 | −0.4486 | −0.4646 | −0.0005 |
| (11)Tk/ImgH | −0.506 | −0.524 | −0.461 | −0.342 |

### Image Pickup Apparatus

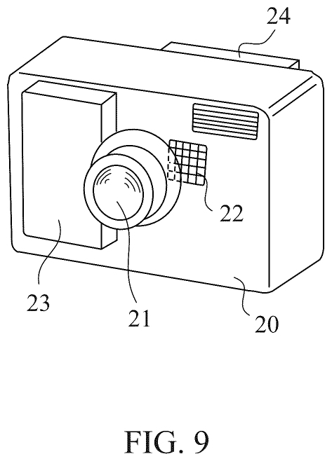

FIG. 9 illustrates a digital still camera as an image pickup apparatus using the optical system according to any one of Examples 1 to 4. Reference numeral 20 denotes a camera body, and reference numeral 21 denotes an imaging optical system including one of the optical systems according to Examples 1 to 4. Reference numeral 22 denotes an image sensor such as a CCD sensor or CMOS sensor built into the camera body 20 that photoelectrically converts an object image formed by the imaging optical system 21 (captures an object image through the optical system). Reference numeral 23 denotes a memory that records image data generated based on a signal from the image sensor 22. Reference numeral 24 denotes an electronic viewfinder including a display element such as a liquid crystal display panel, and configured to display image data to enable the user to observe the object image.

The optical systems according to each example in the image pickup apparatus can provide an image pickup apparatus that has a reduced size and a shorter overall length.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-158026, which was filed on Sep. 12, 2024, and which is hereby incorporated by reference herein in its entirety.

What is claimed is:

1. An optical system comprising:
a plurality of lenses arranged in order from an object side to an image side,
wherein a lens closest to an image plane of the optical system is a negative lens having an inflection point, and
wherein the following inequalities are satisfied:
$$0.5 \leq f / ImgH \leq 0.95$$
$$0.4 \leq EAR / ImgH / 2 \leq 0.75$$
where f is a focal length of the optical system, ImgH is an image height, and EAR is an effective diameter of an image-side lens surface of the negative lens.

2. The optical system according to claim 1, wherein the following inequality is satisfied:
$$0.7 \leq TTL / ImgH \leq 1.3$$
where TTL is a distance on an optical axis from a lens surface having refractive power and disposed closest to an object in the optical system to the image plane.

3. The optical system according to claim 1, wherein the following inequality is satisfied:
$$0 < skd / ImgH \leq 0. 3$$
where skd is an air-equivalent value of a distance on an optical axis from a lens surface having refractive power and disposed closest to the image plane in the optical system to the image plane.

4. The optical system according to claim 1, wherein the plurality of lenses include, in order from the object side, a first lens, a second lens, and a third lens, and
wherein the following inequality is satisfied:
$$0.8 \leq fP / f \leq 1.5$$
where fP is a focal length of a lens having greatest positive refractive power among the first lens, the second lens, and the third lens.

5. The optical system according to claim 1, wherein the plurality of lenses include, in order from the object side, a first lens, a second lens, and a third lens, and
wherein the following inequality is satisfied:
$$0.6 \leq f 13 / f \leq 1.1$$
where f13 is a combined focal length of the first lens, the second lens, and the third lens.

6. The optical system according to claim 1, wherein the negative lens is a biconcave lens, and
wherein the following inequality is satisfied:
$$- 1.1 \leq fR / f \leq - 0.5$$
where fR is a focal length of the negative lens.

7. The optical system according to claim 1, wherein an object-side lens surface of the negative lens has a concave shape toward the object side,
wherein there is an air gap between the negative lens and a lens adjacent to the negative lens on the object side, and
wherein the following inequality is satisfied:
$$- 3. \leq R 1 / \vert R 2 \vert \leq - 0.05$$
where R1 is a radius of curvature of the object-side lens surface of the negative lens, and R2 is a radius of curvature of an image-side lens surface of the lens adjacent to the negative lens on the object side.

8. The optical system according to claim 1, wherein the following inequality is satisfied:
$$0.05 \leq TR / EAR \leq 0.4$$
where TR is a distance on an optical axis between the negative lens and a lens adjacent to the negative lens on the object side.

9. The optical system according to claim 1, wherein an image-side lens surface of the negative lens has an inflection point.

10. The optical system according to claim 1, wherein the following inequality is satisfied:
$$- 1.5 \leq sagmax / sagmin < 0$$
where sagmax and sagmin are a maximum sag amount and a minimum sag amount of an image-side lens surface of the negative lens, respectively.

11. The optical system according to claim 1, wherein the following inequality is satisfied:
$$- 0.60 \leq Tk / ImgH \leq - 0.20$$
where Tk is a distance on an optical axis from the image plane to an exit pupil of the optical system.

12. The optical system according to claim 1, wherein the plurality of lenses include, in order from the object side, a first lens, a second lens, and a third lens, and
wherein the optical system further comprises an aperture stop disposed between any two of the first lens, the second lens, and the third lens, at a position adjacent to the first lens on the object side or at a position adjacent to the third lens on the image side.

13. The optical system according to claim 1, wherein the plurality of lenses include six lenses with positive, negative, positive, positive, positive, and negative refractive powers arranged in this order from the object side to the image side.

14. The optical system according to claim 1, wherein the plurality of lenses include six lenses with positive, negative, positive, negative, positive, and negative refractive powers arranged in this order from the object side to the image side.

15. The optical system according to claim 1, wherein the plurality of lenses include six lenses with positive, negative, positive, positive, negative, and negative refractive powers arranged in this order from the object side to the image side.

16. The optical system according to claim 1, wherein the plurality of lenses include five lenses with positive, negative, positive, positive, and negative refractive powers arranged in this order from the object side to the image side.

17. An optical system comprising:
five or more lenses,
wherein at least two of the five or more lenses are positive lenses, and
wherein a lens closest to an image plane of the five or more lenses is a negative lens having an inflection point.

18. An image pickup apparatus comprising:
an optical system that includes a plurality of lenses arranged in order from an object side to an image side; and
an image sensor configured to capture an object image through the optical system,
wherein a lens closest to an image plane of the optical system is a negative lens having an inflection point, and
wherein the following inequalities are satisfied:
$$0.5 \leq f / ImgH \leq 0.95$$
$$0.4 \leq EAR / ImgH / 2 \leq 0.75$$
where f is a focal length of the optical system, ImgH is an image height, and EAR is an effective diameter of an image-side lens surface of the negative lens.
